(19) United States
(12) Patent Application Publication
(10) Pub. No.: US 2026/0094287 A1
(43) Pub. Date: Apr. 2, 2026

(54) OPTICAL DEPTH ESTIMATION USING SEGMENTATION AND GEOMETRIC PRIORS FOR INTERIOR SPACE MONITORING SYSTEMS AND APPLICATIONS

(71) Applicant: NVIDIA Corporation, Santa Clara, CA (US)

(72) Inventors: Sakthivel SIVARAMAN, Sunnyvale, CA (US); Rajath Shetty, Sunnyvale, CA (US); Braeden Chance Syrnyk, Santa Clara, CA (US)

(21) Appl. No.: 18/903,680

(22) Filed: Oct. 1, 2024

(51) Int. Cl. G06T 7/50; G06T 7/11; G06V 20/59

(52) U.S. Cl. CPC G06T 7/50; G06T 7/11; G06T 2207/10028; G06T 2207/20081; G06T 2207/20084; G06T 2207/30268; G06V 20/59

(57) ABSTRACT

In various examples, optical depth estimation for interior space monitoring systems and applications is disclosed. Absolute 3D depth estimates from monocular image data may be generated using a machine learning model using 3D geometry priors and a joint learning framework that combines depth estimation with object segmentation. Three-dimensional geometry priors provide surface-level information that enriches the model's understanding of the relevant spatial geometry and resolves scale ambiguity in monocular depth estimation within automotive in-cabin environments. The model may include a common (e.g., shared) encoder stage that outputs features extracted from an optical image sensor feed to separate decoder stages that include a depth estimation decoder and a segmentation decoder. Joint learning for depth estimation and segmentation tasks during training achieves a more nuanced understanding of the in-cabin environment, leading to significantly improved depth accuracy.

### BACKGROUND

An occupant monitoring system (OMS) may be used within a vehicle cabin to perform real-time assessments of driver and occupant presence, gaze, alertness, or other conditions. For example, an OMS—using data generated or obtained by sensors of the vehicle or machine—may be used to track the direction of a driver's eye gaze, head pose, or blinking (for example, to detect drowsiness, fatigue, and/or distraction), for hand position and/or gesture detection, child and/or pet-presence detection, and/or in conjunction with the operation of features such as, but not limited to, seat belt reminders, seat heating, and/or smart airbag deployment. Optical image sensor data may also be processed to extract image features to identify and classify the source of motion. Depth perception sensors may use radio waves, laser light, and/or sound waves, for example, to detect the presence or movements of living beings within a vehicle interior (e.g., humans or pets). Such detections may be used within the context of preventing vehicle burglary and/or preventing children or pets from being left alone in the vehicle unintentionally.

### SUMMARY

Embodiments of the present disclosure relate to optical depth estimation model-based depth assessment for interior space monitoring systems and applications. The present disclosure relates to interior space monitoring technologies. More specifically, the systems and methods presented in this disclosure provide for technologies for monocular image-based depth estimation that may be used by an occupant monitoring system (OMS) of a vehicle or other vessel to monitor, for example, a cabin's interior for safety and comfort applications.

In contrast to existing depth estimation technologies, the systems and methods presented in this disclosure provide for an in-cabin depth estimation system that employs three-dimensional (3D) geometry priors (such as—but not limited to—3D vehicle geometry priors) with a joint learning framework that integrates depth estimation with object segmentation. Absolute 3D depth estimates may be generated using a monocular depth estimator that comprises an optical depth estimation machine learning model that inputs optical image sensor data from an optical image sensor. The optical depth estimation model may be trained on 3D geometry priors (e.g., 3D computer assisted drawing (CAD) priors) using a joint learning framework that combines depth estimation with object segmentation. Using 3D geometry priors provides surface-level information about an unoccupied interior space that enriches the optical depth estimation model's understanding of the relevant spatial geometry and resolves scale ambiguity in monocular depth estimation within automotive in-cabin environments. By jointly learning depth estimation and segmentation tasks during training, the optical depth estimation model achieves a more nuanced understanding of the in-cabin environment, leading to significantly improved depth accuracy. The optical depth estimation model may include a common (e.g., shared) encoder stage that outputs features extracted from an optical image sensor feed to separate decoder stages that include a depth estimation decoder and a segmentation decoder. This dual approach not only enhances the accuracy of depth estimation on a metric scale but also improves the reliability of object segmentation and vice versa, thereby significantly contributing to occupant safety and system robustness. The depth estimation decoder inputs features from the encoder stage to produce a depth map of the in-cabin environment as viewed from the optical image sensor.

The segmentation decoder may also input features generated by the shared encoder stage to generate segmentation masks that identify different in-cabin elements such as occupants, seats, regions of interest (invariant regions), and/or personal items. The segmentation decoder may effectively generate a complementary image space to the depth map, because distinct entities in an image are often distinguishable from each other based on characteristics that are relatable to both depth and segmentation. The encoder stage processes image data from an optical image sensor to identify and extract different features from within an image frame. That information extractable from the image data is useful for both learning segmentation and depth estimation tasks. The features produced by the encoder stage represent a richer shared latent representation than if the encoder were trained in a dedicated manner just to perform singular tasks of either depth estimation or segmentation.

The optical depth estimation model disclosed herein may be trained using training data that comprises one or more optical image frames captured from an OMS optical image sensor, and ground truth based on 3D geometry priors representing the vehicle interior where the optical image data was captured. Training the optical depth estimation model comprises a joint learning framework that combines depth estimation with object segmentation—and may update the model during training based on feedback generated using a set of loss functions that include terms for discrepancies between depth and segmentation predictions and the 3D geometry prior-based expectations. For example, during training, characteristics of features as predicted by depth maps and/or segmentation masks produced by the optical depth estimation model may be compared with features derived from the 3D geometry priors. One or more loss functions may be used to minimize discrepancies—guiding the optical depth estimation model towards physically plausible depth and segmentation predictions.

### BRIEF DESCRIPTION OF THE DRAWINGS

The present systems and methods for optical depth estimation model-based depth assessment for interior space monitoring systems and applications are described in detail below with reference to the attached drawing figures, wherein:

FIG. 1 is a data flow diagram illustrating a process for an example optical depth estimation system 100, in accordance with some embodiments of the present disclosure;

FIG. 2 is a training architecture for an optical depth estimation model, in accordance with some embodiments of the present disclosure;

FIGS. 3A and 3B are data flow diagrams for example systems for image-based three-dimensional occupant assessment, in accordance with some embodiments of the present disclosure;

FIG. 4 is a flow diagram showing a method for optical depth estimation, in accordance with some embodiments of the present disclosure;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

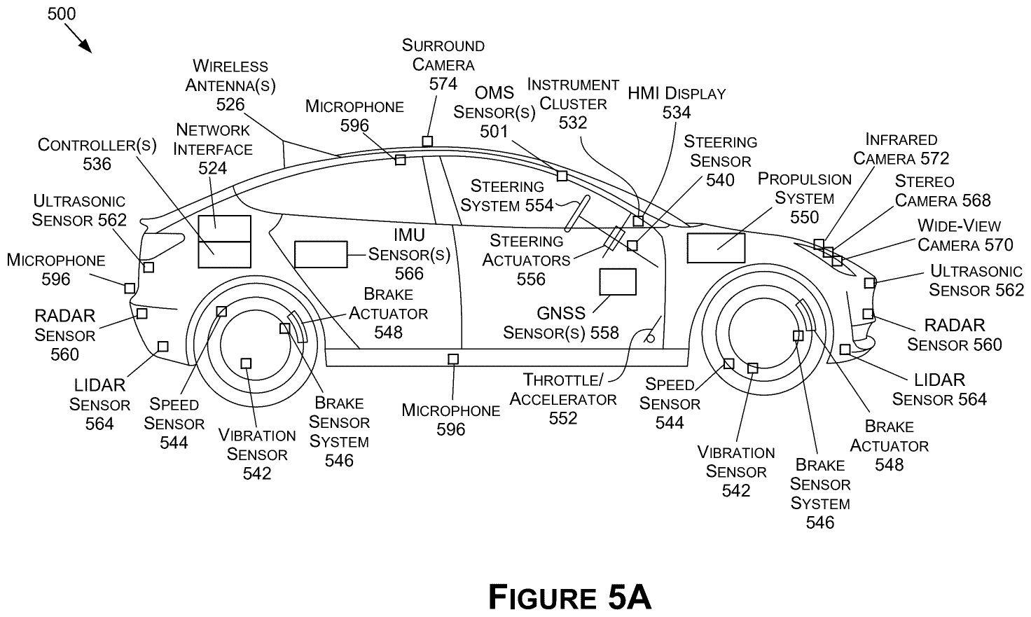

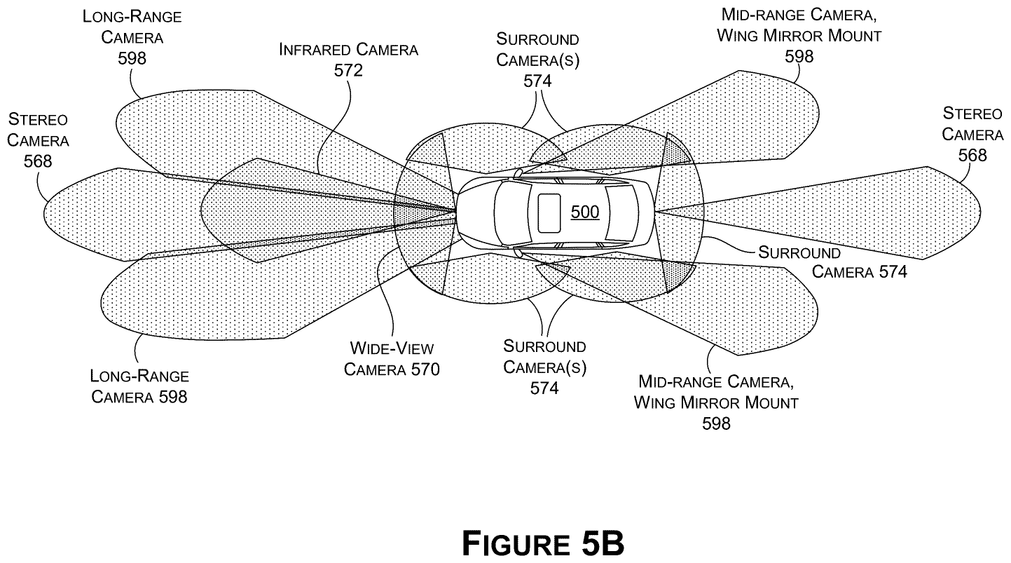

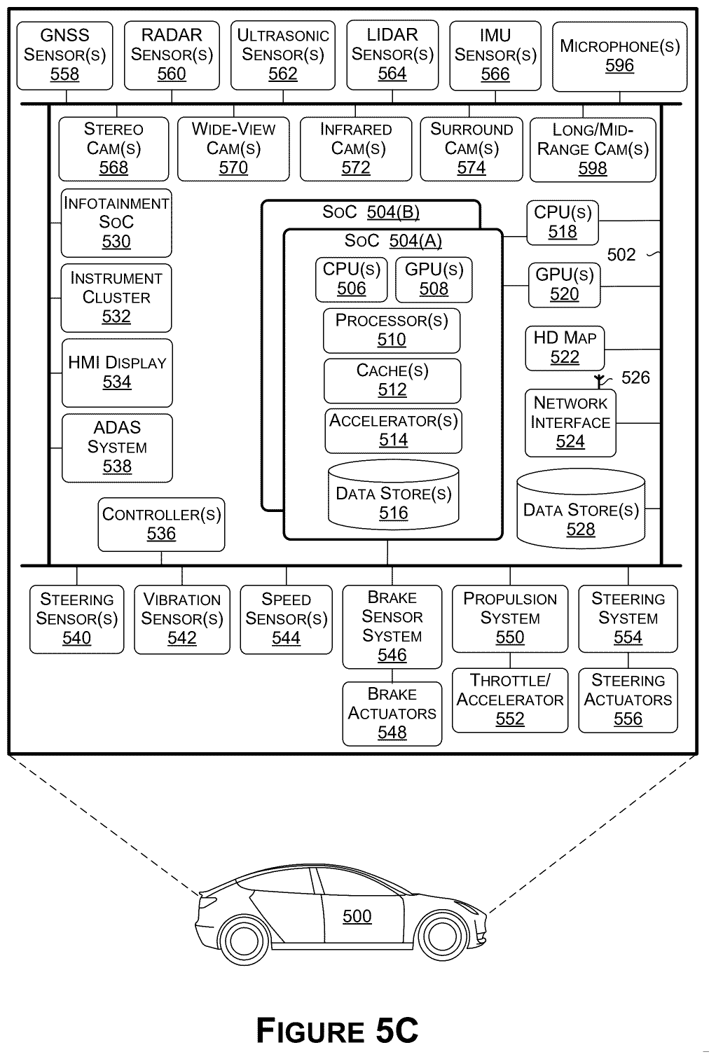

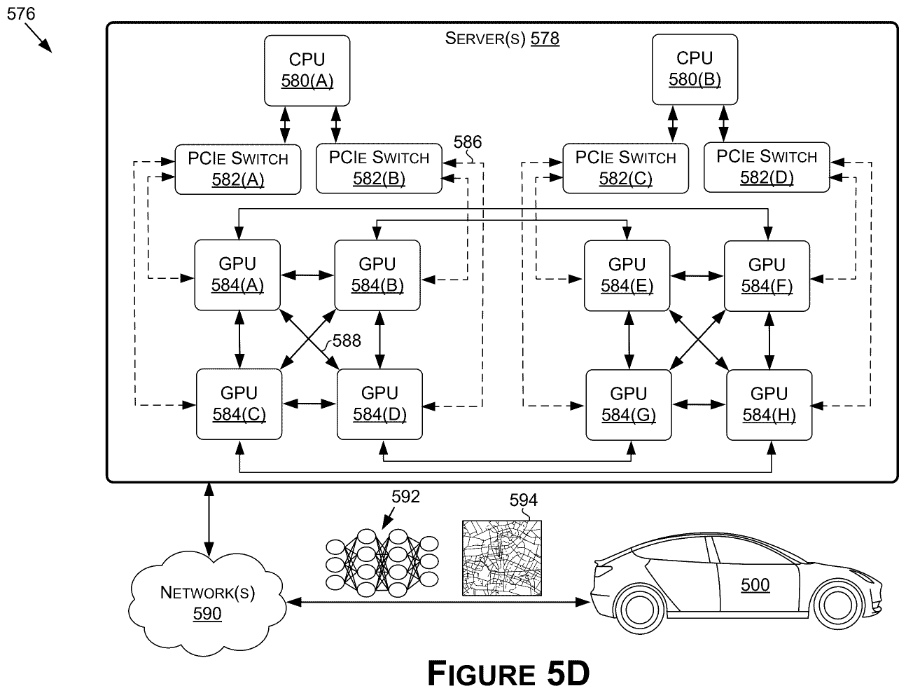

Systems and methods are disclosed related to optical depth estimation model-based depth assessment for interior space monitoring systems and applications. Although the present disclosure may be described with respect to an example autonomous or semi-autonomous vehicle or machine 500 (alternatively referred to herein as “vehicle 500” or “ego machine 500,” an example of which is described with respect to FIGS. 5A-5D), this is not intended to be limiting. For example, the systems and methods described herein may be used by, without limitation, non-autonomous vehicles or machines, semi-autonomous vehicles or machines (e.g., in one or more advanced driver assistance systems (ADASs)), autonomous vehicles or machines, piloted and unpiloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to vehicle occupant monitoring systems, this is not intended to be limiting, and the systems and methods described herein may be used in augmented reality, virtual reality, mixed reality, robotics, security and surveillance, autonomous or semi-autonomous machine applications, and/or any other technology spaces where interior space monitoring technologies may be used.

The present disclosure relates to interior space monitoring technologies. More specifically, the systems and methods presented in this disclosure provide for technologies for monocular image-based depth estimation that may be used in a vehicle occupant monitoring system (OMS) to monitor, for example, a vehicle cabin's interior for safety and comfort applications. With respect to the many tasks that may be performed by an OMS, three-dimensional (3D) depth data has particular utility with respect to determining the size and/or pose of occupants. Child presence detection (CPD) in particular involves, among other things, the task of detecting when a child is an occupant of a vehicle. For example, a child protection system may attempt to assess when an occupant of an idle vehicle is less than a threshold age, and alert the vehicle owner when a child may have been inadvertently left behind inside the vehicle. Size estimation may be an upstream task related to the age estimation task, since a person's size correlates heavily with age and is one of the most observable characteristics of a person that can be used in assessing the age of a vehicle occupant. Particularly with respect to detecting characteristics, such as the 3D shape and/or 3D body pose of a vehicle occupant, traditional systems have used in-cabin depth sensors, such as RADAR sensors, that may directly generate 3D data corresponding to detected objects in the vehicle cabin, and that may penetrate structural elements of the vehicle interior (e.g., car seats) to detect occluded objects not within a line of sight of an optical image sensor.

RADAR sensors, as one example, may produce sensor data that can be used to derive size estimates generally representative of the size of an occupant (e.g., to differentiate a child from an adult occupant) in three dimensions. However, it can be expensive to deploy interior-sensing RADAR sensors in production vehicles. Moreover, the sensor data from a RADAR sensor is of limited resolution that limits its ability to produce 3D body pose estimates that precisely capture the position of body limbs (e.g., for child presence detection and/or occupant age predictions), and primarily rely on sensed motion to sense objects.

Other depth-sensing sensors, such as depth-sensing cameras, also referred to as range cameras, produce a two-dimensional (2D) range image, where pixel values of the range image may correspond to a distance from the sensor to sensed images in the sensor's field of view. However, depth-sensing cameras are also expensive to deploy in production vehicles. Moreover, the accuracy of deriving 3D depth data for an occupant from 2D range images produced by a depth-sensing camera may be limited by factors such as relatively low resolution, short sensing distances, and susceptibility to occlusions and/or optical interference.

Optical image sensor data from monocular optical image sensors, such as a camera that captures standard red, green, blue (RGB), infrared (IR), and/or RGB-IR image frames, may be obtained using relatively inexpensive devices that may already be deployed in the vehicle cabin for one or more purposes (e.g., driver gaze detection). That said, monocular optical image sensors, by themselves, do not generate data that conveys a sense of the 3D position of objects in the captured scene, which makes it difficult to train a machine learning model, such as a deep neural network (DNN), to generate accurate 3D shape, 3D size, and/or 3D body pose estimates for people captured in the 2D images. These systems face significant challenges in accurately estimating depth on a metric scale due to scale ambiguity inherent in monocular vision and the complexity of interpreting cabin environments under variable conditions.

Moreover, depth estimates of vehicle occupants based on 2D images are vulnerable to inaccuracies the more the occupant deviates from an upright posture, such as when the occupant is sitting in a slouched or hunched position and/or turned to one side. This is often because 2D to 3D imaging mapping is an ill-posed problem with ambiguous solutions where, for example, the same 2D projection may be derived from multiple 3D poses. Solutions have been proposed that attempt to estimate affine scale parameters (e.g., a scaling factor and offset factor) based on optimization processes that compare, for example, a reference depth image (e.g., from CAD data) from a vehicle manufacturer against a monocular optical image. However, these solutions are susceptible to noise and misalignment errors between the manufacturer's depth image and the optical image sensor and/or tolerances of the manufactured car. Moreover, affine scale parameters are not necessarily constant across an entire image and/or all possible scenes (e.g., bright lighting scenarios versus dark lighting scenarios). A lack of precise depth information can hinder the effectiveness of advanced safety systems and occupant monitoring solutions.

In contrast to existing depth estimation technologies, the systems and methods presented in this disclosure provide for an in-cabin depth estimation system that employs 3D geometry priors (such as but not limited to 3D vehicle geometry priors) with a joint learning framework that integrates depth estimation with object segmentation. That is, absolute 3D depth estimates may be generated using a monocular depth estimator that comprises an optical depth estimation machine learning model that inputs optical image sensor data from an optical image sensor. In some embodiments, the OMS optical image sensor may comprise a monocular optical image sensor, such as a camera, that captures standard RGB, IR, and/or RGB-IR image frames of the vehicle interior. The optical depth estimation model may be trained on 3D geometry priors (e.g., 3D CAD priors) using a joint learning framework that combines depth estimation with object segmentation. Using 3D geometry priors provides surface-level information about an unoccupied interior space that enriches the optical depth estimation model's understanding of the relevant spatial geometry and resolves the scale ambiguity in monocular depth estimation within automotive in-cabin environments. By jointly learning depth estimation and segmentation tasks during training, the optical depth estimation model achieves a more nuanced understanding of the in-cabin environment, leading to significantly improved depth accuracy. This dual approach not only enhances the accuracy of depth estimation on a metric scale but also improves the reliability of object segmentation and vice versa, thereby significantly contributing to occupant safety and system robustness.

In some embodiments, the optical depth estimation model comprises a neural network architecture (which may be implemented using one or more of a Convolutional Neural Network (CNN), Deep Neural Network (DNN), or other machine learning model architecture(s)). The optical depth estimation model may include a common (e.g., shared) encoder stage that outputs features extracted from an optical image sensor feed to separate decoder stages that include a depth estimation decoder and a segmentation decoder. This shared architecture facilitates efficient learning from in-cabin images while leveraging joint learning to enhance the performance of both depth estimation and segmentation tasks.

In some embodiments, the depth estimation decoder inputs features from the encoder stage to produce a depth map of the in-cabin environment as viewed from the optical image sensor. The depth estimation decoder may include, for example, upscaling layers, convolutional layers to refine depth predictions, and/or skip connections from the encoder stage (e.g., to preserve spatial information).

The segmentation decoder may also input features generated by the shared encoder stage to generate predictions of segmentation masks that identify different in-cabin elements such as occupants, seats, regions of interest (invariant regions), and/or personal items. The segmentation decoder may effectively generate a complementary image space to the depth map, because distinct entities in an image are often distinguishable from each other based on characteristics that are relatable to both depth and segmentation. The encoder stage processes image data from an optical image sensor to identify and extract different features from within an image frame. That information extractable from the image data is useful for both learning segmentation and depth estimation tasks. The features produced by the encoder stage represent a richer shared latent representation than if the encoder were trained in a dedicated manner just to perform singular tasks of either depth estimation or segmentation.

In embodiments, the optical depth estimation model disclosed herein may be trained using training data that comprises one or more optical image frames captured from an OMS optical image sensor and ground truth based on 3D geometry priors representing the vehicle interior where the optical image data was captured. For example, during training, characteristics of features as predicted by depth maps and/or segmentation masks produced by the optical depth estimation model may be compared with features derived from the 3D geometry priors. One or more loss functions may be used to minimize discrepancies—guiding the optical depth estimation model towards physically plausible depth and segmentation predictions. The input of 3D geometry priors during training informs the optical depth estimation model of the expected ground truth distances to surfaces as viewed by the optical image sensor from an empty vehicle—training the optical depth estimation model with a sense of scale to learn relations between the features of the empty vehicle. The 3D geometry priors may be rendered in various forms for use with the optical depth estimation model, such as 3D models of the vehicle's interior (e.g., CAD models), point clouds generated from these models, or depth maps that have been pre-rendered based on the 3D models.

In some embodiments, to prepare for training, the 3D geometry priors may be spatially aligned with real-world images captured by an in-cabin optical image sensor (e.g., within an alignment threshold). For example, a viewpoint of the at least one 3D geometry prior may be aligned with a field of view of the optical image sensor within an alignment threshold. This alignment ensures that the 3D geometry priors and the optical image data feeds correspond spatially, allowing for a direct comparison between the predicted depth maps and the 3D vehicle geometry-based references.

The data alignment of the 3D geometry priors is a process that at least approximately aligns a virtual camera having the field of view of the 3D geometry prior rendered images, with the field of view of the physical OMS optical image sensor in the real vehicle. Data alignment may include, for example, scaling, rotation, and/or translation of the 3D vehicle geometry data to match the OMS optical image sensor's perspective to produce 3D geometry priors that are used as input to the optical depth estimation model. Data alignment thus essentially adjusts the 3D geometry priors such that a rendered image derived from the 3D geometry priors accurately represents an absolute depth image from the perspective of the physical OMS optical image sensor.

It should be noted that in some embodiments, the data alignment between the image sensor and the 3D geometry priors may be performed without explicitly determining an extrinsic calibration transform between the two. For example, in production vehicles, the mounting tolerance of an OMS optical image sensor may allow for a range of variances (e.g., +/−5 degrees) in the field of view between individual vehicles. As such, during training of the optical depth estimation model, random variations may be introduced in the data alignment of the 3D geometry priors so that the model learns to produce robust depth maps and/or segmentation masks, even given mounting variations with the OMS optical image sensor. The optical depth estimation model does not need to know vehicle specific OMS optical image sensor calibration parameters and/or mounting tolerances to leverage the 3D geometry priors. As such, a general data alignment may be valid across an entire vehicle line (e.g., vehicles of the same vehicle model) without the need to perform a factory calibration of the OMS optical image sensor for each individual vehicle that is manufactured. For example, the optical depth estimation model may learn to determine when there is a misalignment, and accordingly to learn the correct parameters to address a small misalignment in a latent manner.

In some embodiments, to use the 3D geometry priors effectively, the architecture of the encoder stage is designed to take as inputs both the optical image sensor data and the 3D geometry priors. Alternatively, or additionally, 3D geometry priors can be integrated as inputs to intermediate layers of the encoder stage, serving as a reference or guide with which the optical depth estimation model learns to align its depth and segmentation predictions. In some embodiments, the optical depth estimation model may include functions to align features from the optical image sensor input (real in-cabin images) with features from the 3D geometry priors—for example using a Siamese network structure or through explicit feature-matching layers that minimize the distance between feature vectors extracted from sensor-captured images and 3D geometry prior rendered images.

During training, the optical depth estimation model may input training data where an individual training sample may include a pairing of a real-world optical sensor image and a corresponding 3D geometry prior. The training process leverages these pairs to teach the optical depth estimation model the relationship between visual features appearing in the images and the geometric structures represented in the priors. The optical depth estimation model learns to infer depth information from single images by relating observed features to known geometric structures.

As mentioned above, the architecture of the optical depth estimation model comprises a machine learning model that includes a shared encoder stage that feeds extracted features from an optical image sensor feed to separate decoder stages that include a depth estimation decoder and a segmentation decoder. Training the optical depth estimation model accordingly comprises a joint learning framework that combines depth estimation with object segmentation—and may update the model during training based on feedback generated using a set of loss functions that include terms for discrepancies between depth and segmentation predictions and the 3D geometry prior-based expectations.

In some embodiments, with respect to training for depth estimation accuracy, a consistency loss function provides a loss component that penalizes discrepancies between the predicted depth maps from real in-cabin images and corresponding depth map(s) rendered from the 3D geometry prior. The consistency loss function may be based on a perceptual loss function (e.g., a loss function that measures the difference between the high-level features of two images and/or a loss function implemented using a pre-trained Very Deep Convolutional Network (VGG) loss network) that considers structural similarities while segmenting out regions of the scene that are not static. In some embodiments, with respect to training for segmentation accuracy, an edge alignment loss may be used to quantify discrepancies in predicted depth maps to ensure the edges in the depth map align with the edges of the 3D geometry prior. That is, in contrast to strictly limiting training to minimize a depth estimation accuracy loss, the shared encoder stage of the optical depth estimation model is further learning based on a segmentation loss to extract the edges where depth continuities in a captured image can be expected to occur.

In some embodiments, training is performed using training sample pairs (e.g., pairs of real-world images and corresponding 3D geometry priors) that include variations in interior configurations. Static regions of a vehicle interior include immovable features (e.g., that are not reconfigurable with respect to their shape and/or position) such as, but not limited to, features such as hand rests, dashboard surfaces, door pillars, or similar body support structures. Dynamic features, in contrast, may have user-adjustable configurations such as, but not limited to, seat positions, adjustable seat belt anchors or other components of seat belts, steering wheel columns, operable window glass surfaces, and/or the placement of temporary objects such as child safety seats and/or booster seats. When optical image data is passed to the optical depth estimation model during training, it latently learns to identify what regions of the scene to focus on to facilitate accurate depths and segmentation predictions (e.g., static regions), and not rely on regions that may shift in position from one sample of training data to the next (e.g., dynamic regions). By minimizing losses associated with both depth estimation accuracy and segmentation accuracy, the optical depth estimation model will learn to focus on static regions in a latent manner. That said, in some embodiments, dynamic regions in the 3D geometry priors used for training may be explicitly masked out to assist the network in focusing on the static regions alone.

In some embodiments, the training may include using a rendered image derived from a 3D geometry prior, and depth maps generated by a depth estimation decoder, to compute a regularization feedback. For example, in addition to the primary loss functions for depth and segmentation, in some embodiments, the loss feedback to the optical depth estimation model may also include a regularization term to adjust the optical depth estimation model to ensure that predictions do not deviate significantly from the expectations defined by the 3D geometry prior.

In deployment applications, the optical depth estimation model trained as described herein may be used as an inference model to generate a depth map based on an image frame of an OMS optical image sensor. Inputs to the optical depth estimation model may include optical image data captured by an optical image sensor (e.g., a production vehicle interior scene captured by an OMS camera) and a representation of a 3D geometry prior for the vehicle interior (e.g., a rendered image derived from a 3D geometry prior). Based on the training, the optical depth estimation model may infer depth information from one or more image frames by relating observed features to learned depth information for segments representing static geometric structures. That is, the optical depth estimation model may infer a segmentation of the scene based on the optical image data and the representation of the 3D geometry prior, predict a depth parameter scaling for the non-static regions, and output a prediction of depth information in the form of a depth map that may be aligned pixel-wise with the optical image data. A distance to features appearing at given pixel locations of a captured image frame—from the OMS optical image sensor that captured the image frame—may therefore be determined based on referencing those locations on the depth map. That is, the value of a pixel on the depth map provides a depth estimate of the feature appearing at a corresponding pixel of the image frame.

Depth maps produced by embodiments of the optical depth estimation model described herein may be used as inputs to support various OMS functions, such as but not limited to an occupant evaluation function to determine a 3D representation of a vehicle occupant (such as their 3D size, 3D shape, and/or 3D pose). The optical depth estimation model may output a depth map based on an input comprising an image frame from the OMS optical image sensor. The pixel values of the depth map may correspond to a distance from the OMS optical image sensor to sensed features in the sensor's field of view appearing in the image frame. Therefore, a depth map output from the optical depth estimation model provides the occupant evaluation function with depth data corresponding to the pixels of the image frame that represent features corresponding to at least a portion of the occupant, including pixels that represent kinematic elements (such as the at least one body joint) of the occupant captured by the scale-normalized 3D pose.

In some embodiments, the occupant evaluation function may generate a 3D representation of an occupant that includes at least one characteristic representative of a size of the occupant, such as a 3D pose and/or a 3D shape. The OMS and/or other vehicle system may use the 3D representation for various purposes, such as estimating other characteristics representative of a size of the occupant (e.g., estimating the occupant's height and/or body limb lengths). In some embodiments, the occupant evaluation function may generate one or more outputs comprising the 3D representation of the occupant that are used to control at least one operation of the vehicle based on the depth map and/or the estimated occupant characteristic. For example, the characteristic representing the size of the occupant may be used in conjunction with a child-presence detection system to estimate an age of the occupant and/or control an alert system (e.g., alarm and/or notification systems) based on determining that an occupant under an estimated age threshold may have been inadvertently left alone in the vehicle. In some embodiments, the characteristic representing the size of the occupant may be used in conjunction with other vehicle safety features. For example, in some embodiments, airbag deployments, driver monitoring systems (e.g., gaze detection and/or hands-on-steering-wheel detection), human machine interface (HMI) applications, and/or other vehicle functions may be controlled based at least on a 3D pose and/or size estimate of a vehicle occupant derived at least in part from depth and/or scaling data determined by reference to a depth map generated by the optical depth estimation model.

In some embodiments, an occupant evaluation function of a vehicle may process an input optical image frame from an OMS optical image sensor to derive a 3D pose estimate for a vehicle occupant. In such an embodiment, the representation of one or more features corresponding to at least a portion of the occupant may comprise a scale-normalized 3D pose estimate. For example, the occupant evaluation function may execute a person-detection model and a 3D pose detection model (e.g., both of which may be implemented using one or more of a Convolutional Neural Network (CNN), Deep Neural Network (DNN), or other machine learning model architecture(s)). The image frame may be processed by the person-detection model, which recognizes features of the occupant and crops the image to produce a cropped image (e.g., an image bounded by an outline of the occupant). Based on the cropped image, the 3D pose detection model may generate a scale-normalized 3D pose of the occupant. The scale-normalized 3D pose may comprise a 3D representation of kinematic elements (e.g., body limbs and/or joints) that indicates 3D coordinates for the kinematic elements. In other words, the 3D pose detection model receives the cropped images of the occupant from the person-detection model and produces a 3D pose estimate for the vehicle occupant from the captured image frame. The 3D pose detection model may be trained based on synchronized multi-view images of training subjects to produce 3D pose estimates using coordinates that are scale-normalized. That is, the 3D coordinates are scale-normalized in that they may indicate the dimensions and/or relative positions of kinematic elements in relation to each other, rather than in absolute terms (e.g., linear measurement units). To map the scale-normalized 3D pose of the occupant to an absolute 3D pose, the occupant evaluation function may use a depth map generated by the optical depth estimation model described herein to determine an absolute 3D depth corresponding to at least one or more kinematic elements (e.g., body joints) detected from at least one image frame.

It should be understood that an OMS that performs occupant evaluation may be used in an interior space of a vehicle or vessel besides a passenger cabin. For example, the interior space described in the embodiments herein may determine 3D pose and/or shape estimates using optical image data for occupants within a trunk, cargo bed, or other space. Embodiments presented in this disclosure may be implemented in the context of vehicle occupant monitoring systems (including driver monitoring systems) for vehicles such as, but not limited to, non-autonomous vehicles, semi-autonomous vehicles, piloted and unpiloted robots or robotic platforms, warehouse vehicles, off-road vehicles, vehicles coupled to one or more trailers, aircraft, spacecraft, boats, shuttles, emergency response vehicles, construction vehicles, underwater crafts, drones, and/or other vehicle types. That said, the optical depth estimation model is not limited to use with vehicle applications, but may be used to generate depth estimates from a monocular optical image frame in other system and applications where a 3D environment may be represented by 3D geometry priors. For example, 3D geometry priors may represent features of spaces such as retail shops, bank lobbies, hospital rooms, warehouse areas, gymnasiums, containers, airport terminals, mines, factories, construction zones, and/or studio sets, or any other spatially constrained 3D environment. The optical depth estimation model may be trained in the same manner discussed herein using a joint learning framework based on training data comprising pairs of real-world optical sensor images (from a fixed location image sensor viewing the space) and corresponding 3D geometry priors (e.g., from a CAD of the static space).

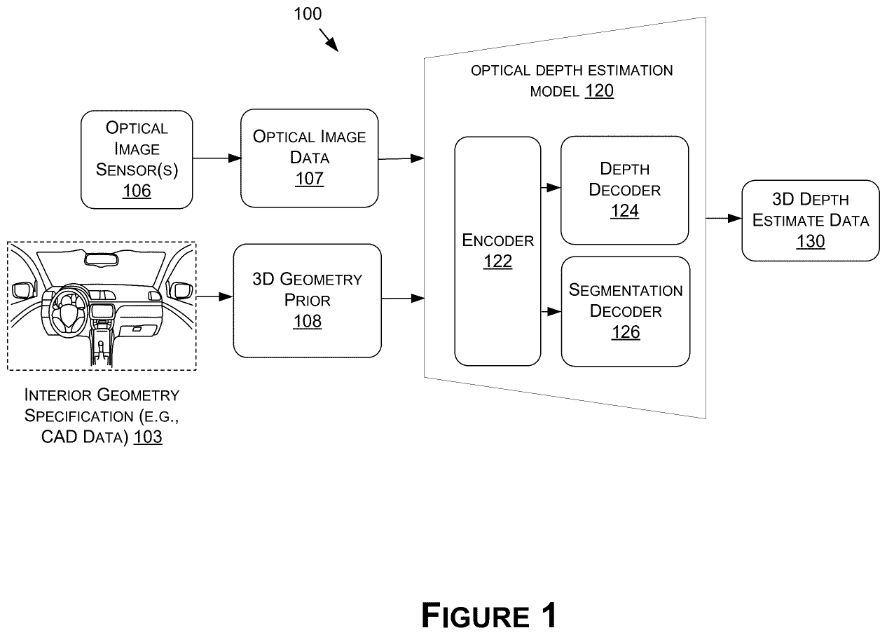

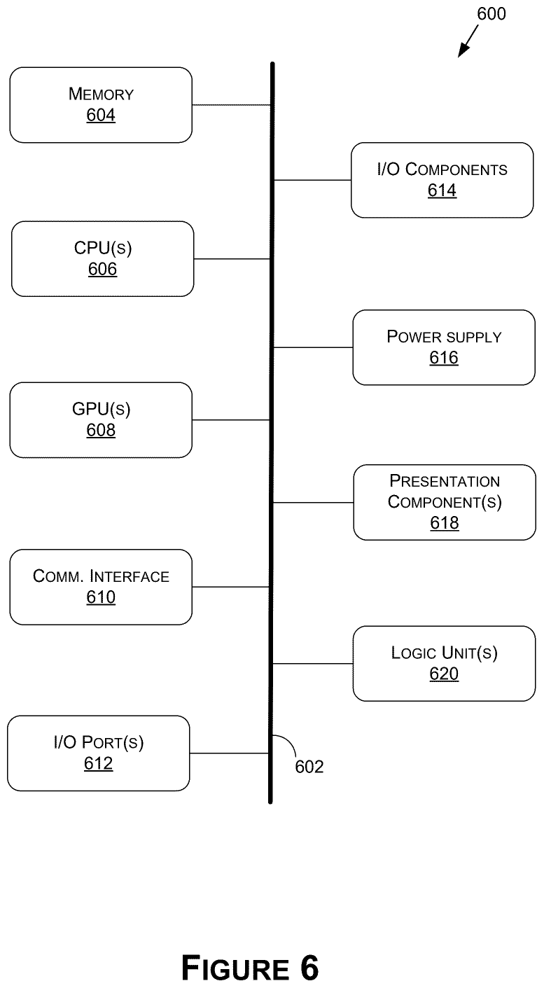

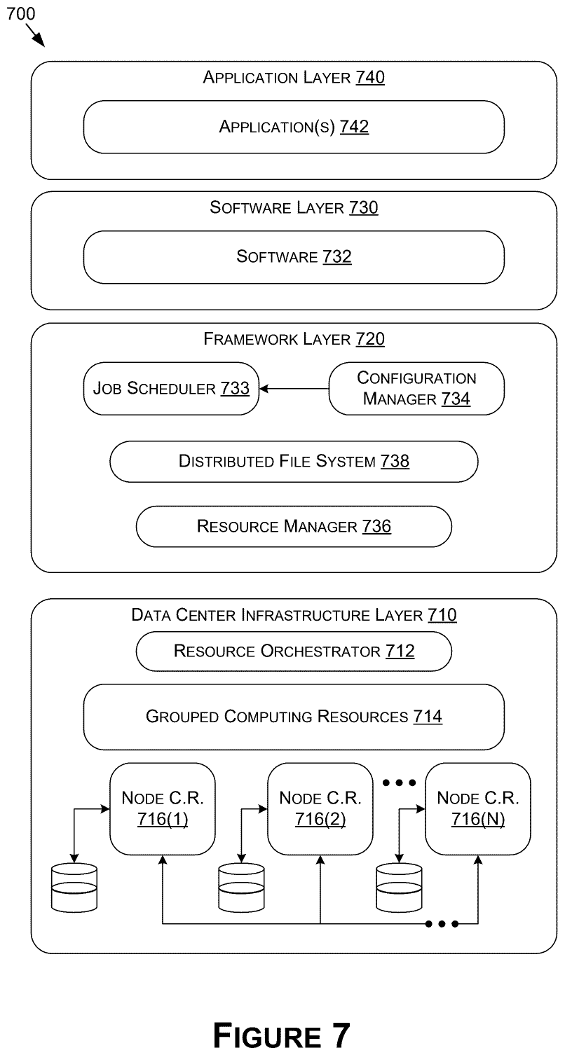

With reference to FIG. 1, FIG. 1 is a data flow diagram illustrating a process for an example optical depth estimation system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 500 of FIGS. 5A-5D, example computing device 600 of FIG. 6, and/or example data center 700 of FIG. 7.

As illustrated in FIG. 1, an example optical depth estimation system 100 may comprise an optical depth estimation model 120 that can generate 3D depth estimate data 130 based on optical image data 107 and at least one 3D geometry prior 108. The optical image data 107 may comprise one or more image frames of an interior space described at least in part by the 3D geometry prior 108. The 3D geometry prior 108 may be rendered in various forms based on an interior geometry specification data 103 (e.g., a CAD model) for use as an input to the optical depth estimation model 120. For example, a 3D geometry prior 108 may comprise a 3D model of the interior space (e.g., a CAD model), a point cloud generated from a 3D model, and/or one or more depth maps rendered based on such a 3D model. In some embodiments, the interior geometry specification data 103 and/or 3D geometry prior 108 may represent a vehicle interior space (e.g., a cabin, cargo space, or other interior space of a vehicle). However, the interior geometry specification data 103 and/or 3D geometry prior 108 are not limited to representations of a vehicle interior space. In some embodiments, interior geometry specification data 103 and/or 3D geometry prior 108 may represent structural features of spaces such as retail shops, bank lobbies, hospital rooms, warehouse areas, gymnasiums, containers, airport terminals, mines, factories, construction zones, and/or studio sets. That is, interior geometry specification data 103 and/or 3D geometry prior 108 may represent any interior space defined by a bounded spatially constrained 3D environment. It should be understood that an interior space need not be a fully enclosed or sealed space, but may include a partially enclosed volume having bounds definable by static structural features (e.g., an open-air stadium, pergola, gazebo, and/or amphitheater) that may be represented by a 3D geometry prior 108. In some embodiments, the optical image data 107 may comprise one or more image frames of the interior space, as captured by one or more optical image sensors 106. In some embodiments, the optical image sensor(s) 106 may comprise one or more occupant monitoring system (OMS) sensor(s) 501 such as described with respect to the vehicle 500. In some embodiments, the optical image data 107 may be captured by an optical image sensor 106 comprising a monocular camera, such as an RGB, IR, and/or RGB-IR camera. In some embodiments, optical image data 107 may comprise simultaneously captured image frames from multiple optical image sensors 106 that are stitched together to form a composite image frame of the interior space for input to the optical depth estimation model 120.

As shown in FIG. 1 and discussed herein, the optical depth estimation model 120 may comprise a shared encoder stage, shown as encoder 122, that outputs features extracted from optical image data 107 to separate decoder stages that include a depth decoder 124 and a segmentation decoder 126. This shared architecture facilitates efficient learning from in-cabin images while leveraging joint learning to enhance the performance of both depth estimation and segmentation tasks. The optical depth estimation model 120 comprises a neural network architecture, which may be implemented, for example, using one or more of a Convolutional Neural Network (CNN), Deep Neural Network (DNN), or other machine learning model architecture(s). Based on the optical image data 107 and the 3D geometry prior 108, the optical depth estimation model 120 may generate a prediction of 3D depth estimate data 130. The 3D depth estimate data 130 may comprise a depth map where the value of each pixel on the depth map corresponds to a depth estimate of the feature appearing at a corresponding pixel location of the optical image data 107. That is, the value of each pixel on the depth map may indicate an estimated distance from the optical image sensor 106 to the surface of a feature within the interior space as captured by the optical image data 107. The optical depth estimation model 120 is trained to latently learn to identify what regions of the interior space to focus on to facilitate accurate depth and segmentation predictions (e.g., static regions), and not rely on regions that may shift in position from one sample of training data to the next (e.g., dynamic regions). Based on training, the optical depth estimation model 120 may infer depth information from one or more image frames of optical image data 107 by relating observed features to learned depth information for segments representing static geometric structures. That is, the optical depth estimation model 120 may infer a segmentation of the interior space scene based on the optical image data 107 and the representation of the 3D geometry prior 108, predict a depth parameter scaling for the non-static regions, and output a 3D depth estimate data 130 in the form of a depth map that may be aligned pixel-wise with the optical image data 107.

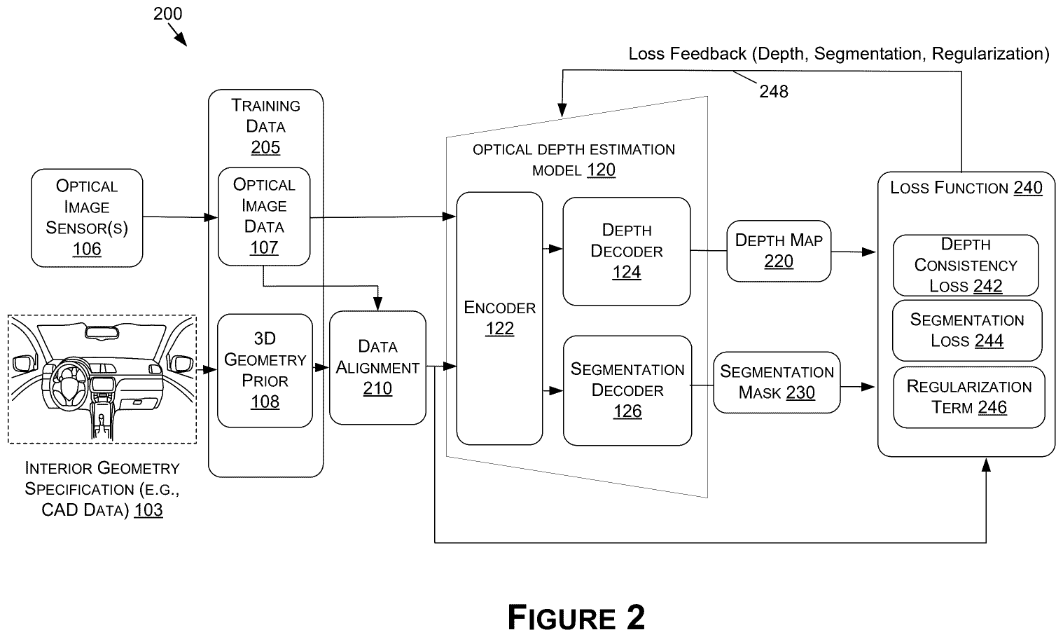

As illustrated in the training architecture 200 illustrated in FIG. 2, the optical depth estimation model 120 may be trained on a joint learning framework that integrates depth estimation with object segmentation. The multi-decoder architecture of the optical depth estimation model facilitates efficient learning from interior space images while leveraging joint learning to enhance the performance of both depth estimation and segmentation tasks. The optical depth estimation model 120 may be trained using training data 205 that comprises a pairing of a real-world optical sensor image and a corresponding 3D geometry prior. In the example of FIG. 2, training data 205 may include a pairing that comprises optical image data 107 (e.g., optical image frames captured from an OMS optical image sensor), and ground truth 3D geometry priors 108 representing the interior space (e.g., vehicle interior) where the optical image data was captured. The training architecture 200 leverages these training data pairs to teach the optical depth estimation model 120 the relationship between visual features appearing in the optical image data 107 and the geometric structures represented in the 3D geometry priors 108. The optical depth estimation model 120 learns to infer depth information from single images by relating observed features to known geometric structures.

In some embodiments, the 3D geometry prior(s) 108 may be spatially aligned with the real-world images represented in the optical image data 107, as shown by data alignment 210. Data alignment 210 ensures that the 3D geometry priors 108 and the optical image data 107 correspond spatially, allowing for a direct comparison between the predicted depth maps 220 and the 3D geometry-based references provided by the 3D geometry prior(s) 108.

The encoder 122 processes the optical image data 107 to identify and extract different features from within an image frame that is useful for learning both segmentation and depth estimation tasks. The input of 3D geometry prior(s) 108 during training inform the optical depth estimation model 120 of the expected ground truth distances to surfaces as viewed by the optical image sensor 106 with respect to an unoccupied interior space—training the optical depth estimation model 120 with a sense of scale to learn relations between the features of the empty vehicle. The depth decoder 124 is fed the features from the encoder 122 to generate an output comprising a depth map 220 of the interior environment as viewed from the optical image sensor(s) 106. The depth decoder 124 may include, for example, upscaling layers, skip connections from the encoder 122 stage (e.g., to preserve spatial information), and/or convolutional layers to refine depth predictions. The segmentation decoder 126 feeds the features from the encoder 122 to generate a segmentation mask 230 that identifies different in-cabin elements such as occupants, seats, regions of interest (e.g., dynamic versus static/invariant regions), and/or personal items. The segmentation decoder 126 may effectively generate a segmentation mask 230 that provides a complementary image space to the depth map, because distinct entities in an image are often distinguishable from each other based on characteristics that are relatable to both depth and segmentation.

As shown in FIG. 2, the training architecture 200 comprises a loss function 240 to generate a loss feedback 248 used to update the model during training. The loss feedback 248 may be generated by the loss function 240 based on computing a depth consistency loss 242 (e.g., a depth estimation accuracy loss) and a segmentation loss 244 (e.g., an edge alignment loss) using the at least one 3D geometry prior 108 as the basis for ground truth. That is, during training, characteristics of features as predicted by depth map 220 and/or segmentation mask 230 may be compared with features derived from the 3D geometry priors 108 to compute the loss feedback 248. Because the optical depth estimation model 120 is updated with a loss feedback 248 that integrates depth estimation with object segmentation, the features produced by the encoder 122 represent a richer shared latent representation than if the encoder were trained in a dedicated manner just to perform singular tasks of either depth estimation or segmentation. In some embodiments, with respect to training for depth estimation accuracy, the depth consistency loss 242 provides a loss component to the loss feedback 248 that penalizes discrepancies between the predicted depth map 220 from the optical image data 107 and a corresponding depth map rendered from the 3D geometry prior 108. The depth consistency loss 242 may be computed based on a perceptual loss function (e.g., a loss function that measures the difference between the high-level features of two images and/or a loss function implemented using a pre-trained Very Deep Convolutional Network (VGG) loss network) that considers structural similarities while segmenting out regions of the scene that are not static. In some embodiments, with respect to training for segmentation accuracy, the segmentation loss 244 may be based on an edge alignment loss to quantify discrepancies between edges of segments in the segmentation mask 230 with the edges of the 3D geometry prior 108. The segmentation loss 244 provides a loss component to the loss feedback 248 that penalizes discrepancies in edge alignment. The loss feedback 248 is fed back to adjust one or more parameters of the optical depth estimation model 120 and iteratively adjust the optical depth estimation model 120 to minimize the depth consistency loss 242 and segmentation loss 244. By minimizing losses associated with both depth estimation accuracy and segmentation accuracy (depth consistency loss 242 and segmentation loss 244), the optical depth estimation model 120 will learn to focus on static regions in a latent manner. In some embodiments, dynamic regions in the 3D geometry priors 108 used for training may be explicitly masked out to help assist the network to focus on the static regions alone. In some embodiments, the loss function 240 may compute a regularization term 246 that is fed back to the optical depth estimation model 120 with the loss feedback 248 (e.g., to adjust a scaling so that predictions do not deviate significantly from the expectations defined by the 3D geometry prior 108).

In some embodiments, the optical depth estimation model 120 trained as described herein may be used as an inference model in deployment applications (such as in vehicle 500) to generate a depth map based on an image frame of an optical image sensor (such as OMS sensor 501). Inputs to the optical depth estimation model may include optical image data captured by the optical image sensor and a representation of a 3D geometry prior for the interior space (e.g., a rendered image derived from a 3D geometry prior).

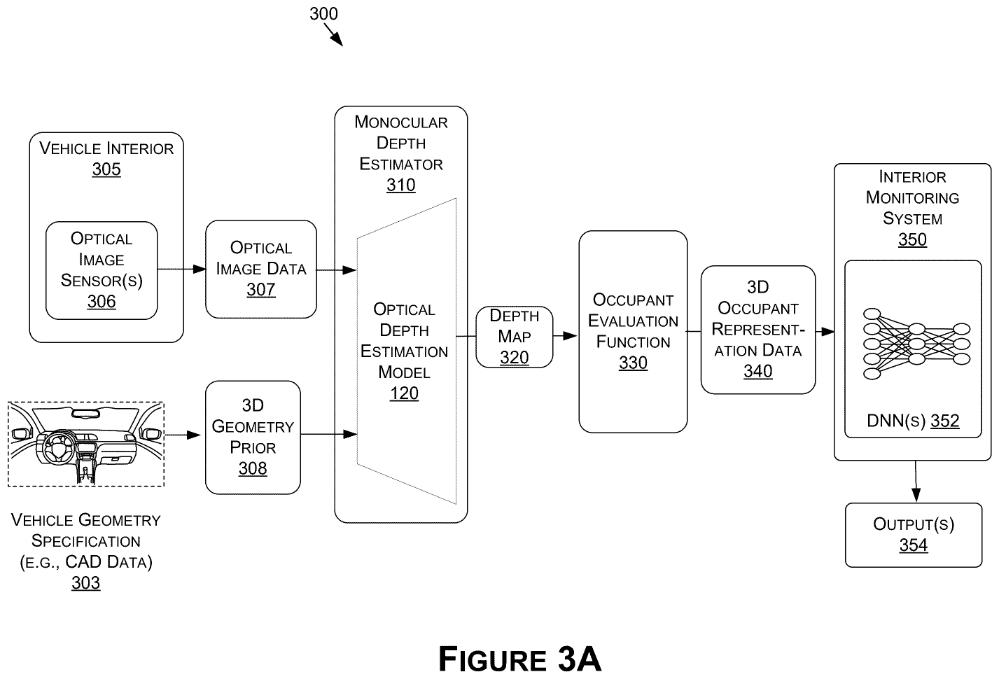

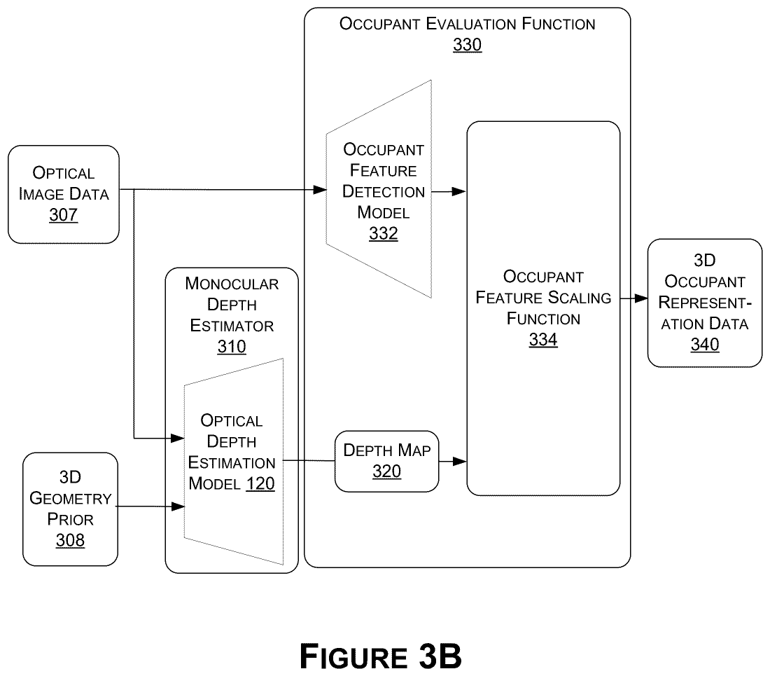

For example, referring to FIGS. 3A and 3B, FIG. 3A is an example data flow diagram for a system 300 for an image-based three-dimensional occupant assessment comprising an optical depth estimation model 120, in accordance with some embodiments of the present disclosure. In some embodiments, the image-based three-dimensional occupant assessment system 300 may include a monocular depth estimator 310. The monocular depth estimator 310 may comprise an optical depth estimation model 120 (as described with respect to any of the embodiments disclosed herein) that receives optical image data 307 and 3D geometry prior 308. In some embodiments, an optical image sensor 306 (e.g., OMS sensor 501) may be positioned within a vehicle interior 305 (e.g., the interior of vehicle 500) to capture optical image data 307—where the optical image data 307 comprises a representation of a vehicle occupant (e.g., an optical image frame) located within the vehicle interior 305. The optical image sensor 306 may comprise, for example, a camera or other optical sensor that captures RGB, IR, and/or RGB-IR image frames. The 3D geometry prior 308 may be rendered in various forms based on vehicle geometry specification data 303 (e.g., a CAD model of the vehicle interior 305, such as interior geometry specification data 103) for use as an input to the optical depth estimation model 120. For example, a 3D geometry prior 308 may comprise a 3D model of the interior space (e.g., a CAD model), a point cloud generated from a 3D model, and/or one or more depth maps rendered based on such a 3D model. The optical depth estimation model 120 processes the optical image data 307 and 3D geometry prior 308 to generate at least one predicted depth map 320. The depth map 320 may be input to an occupant evaluation function 330 to produce 3D occupant representation data 340. As discussed herein, the optical depth estimation model 120 may infer a segmentation of the scene based on the optical image data 307 and the representation of the 3D geometry prior 308, predict a depth parameter scaling for the non-static regions appearing in the optical image data 307, and output a prediction of depth information in the form of the depth map 320 that may be aligned pixel-wise with the optical image data 307. That is, a distance to features appearing at given pixel locations of a captured image frame from the optical image data 307 may be determined based on referencing corresponding pixel locations on the depth map. The depth map 320 output from the optical depth estimation model 120 provides the occupant evaluation function 330 with depth data corresponding to the pixels of the image frame that represent features corresponding to at least a portion of an occupant, including pixels that represent kinematic elements (such as the at least one body joint) of the occupant captured by the scale-normalized 3D pose.

The 3D occupant representation data 340 may include at least one characteristic representative of a size of the occupant (e.g., the occupant's height and/or body limb lengths). Characteristics included in the 3D occupant representation data 340 may comprise a representation such as a 3D pose estimate, a 3D size estimate, and/or a 3D shape estimate of the vehicle occupant. At least one operation of the vehicle may then be controlled based on the characteristic. For example, based at least in part on the 3D occupant representation data 340, an interior monitoring system 350 (which may implement one or more components of the OMS) may generate one or more output(s) 354. Output(s) 354 may be generated using one or more machine learning models and/or deep neural networks (DNNs) 352. As an example, the interior monitoring system 350 may use 3D occupant representation data 340 (either alone or in combination with other data such as optical image data 307) to predict the presence and/or location of occupants—such as objects, persons, and/or animals—within the space of vehicle interior 305. Other systems of the vehicle 500 may determine one or more actions to take based on the predictions and/or may control other tasks or operations. For example, based on output(s) 354, an alarm or warning may be generated, door locks and/or windows may be operated, various functions may be turned on/off, data for a digital assistant, chat bot, digital avatar, and/or the like may be generated, and/or air conditioning or air circulation functions may be operated. In some embodiments, the characteristic representing the size of the occupant from the 3D occupant representation data 340 may be used in conjunction with a child presence detection system to estimate an age of the occupant, and/or control an alert system (e.g., alarm and/or notification systems) based on determining that an occupant under an estimated age threshold may have been inadvertently left alone in the vehicle. In some embodiments, the characteristic representing the size of the occupant may be used in conjunction with other vehicle safety features. For example, in some embodiments, airbag deployments, driver monitoring systems, HMI applications, and/or other vehicle functions may be controlled based at least on a 3D pose, 3D shape, and/or 3D size estimate of the vehicle occupant provided by the 3D occupant representation data 340.

As shown in FIG. 3B, in some embodiments, the occupant evaluation function 330 may comprise an occupant feature detection model 332 and an occupant feature scaling function 334. The occupant feature detection model 332 and/or occupant feature scaling function 334 may be implemented, for example, using a machine learning module, such as implemented using a convolutional neural network (CNN), a deep neural network (DNN), and/or other neural network architecture. The occupant feature detection model 332 generates a representation of one or more features of a vehicle occupant based on optical image data 307. The optical depth estimation model 120 generates a depth map 320 that includes depth data corresponding to elements appearing within the vehicle interior 305 (e.g., a depth from the optical image sensor 106 to the respective elements) based on the optical image data 307 and 3D geometry prior 308 as described herein. In some embodiments, the occupant evaluation function 330 may apply a representation of one or more features of a vehicle occupant from the occupant feature detection model 332 and the depth map 320 to the occupant feature scaling function 334 to determine an absolute (e.g., true-scale) depth corresponding to the one or more occupant features and/or generate a three-dimensional representation of the occupant that is output as 3D occupant representation data 340.

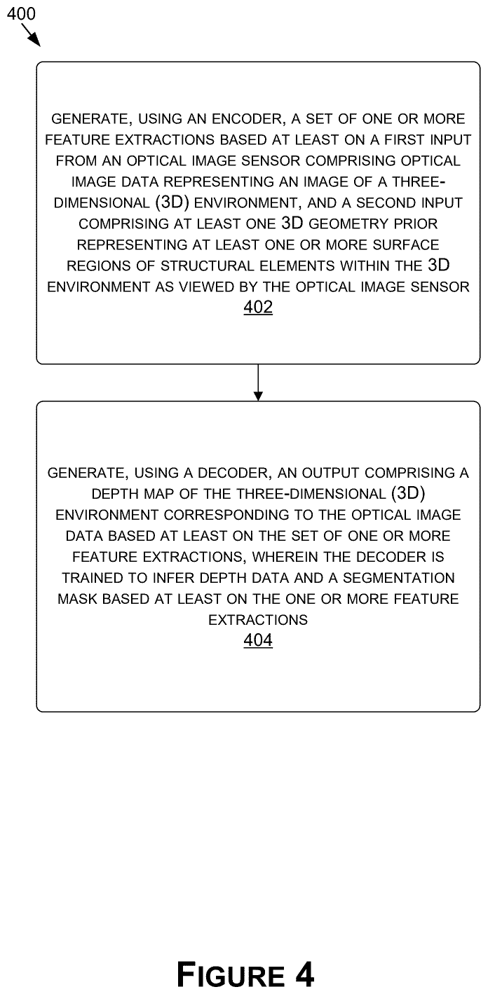

Now referring to FIG. 4, FIG. 4 is a flow diagram showing a method 400 for optical depth estimation, in accordance with some embodiments of the present disclosure. The features and elements described herein with respect to the method 400 of FIG. 4 may be used in conjunction with, in combination with, or substituted for elements of any of the other embodiments discussed herein and vice versa. Further, the functions, structures, and other descriptions of elements for embodiments described in FIG. 4 may apply to like or similarly named or described elements across any of the figures and/or embodiments described herein and vice versa.

Each block of method 400, described herein, comprises a computing process that may be performed using any combination of hardware, firmware, and/or software. For instance, various functions may be carried out by one or more processors comprising processing circuitry and executing instructions stored in memory. The methods may additionally, or alternatively, be embodied as computer-usable instructions stored on computer storage media. The methods may be provided by a standalone application, a service or hosted service (standalone or in combination with another hosted service), or a plug-in to another product, to name a few. In addition, method 400 is described, by way of example, with respect to the optical depth estimation model 120 described in FIGS. 1 and 2 and 3A-3B. However, these methods may additionally or alternatively be executed by any one system, or any combination of systems, including, but not limited to, those described herein.

In some embodiments, method 400 may generally be directed to controlling an operation of a machine based at least on generating a depth map of estimated depths corresponding to a three-dimensional (3D) environment based at least on monocular optical image data representing an image of the 3D environment and at least one 3D geometry prior representing the 3D environment, wherein the depth map is generated using a depth estimation model trained to infer compute depth maps based at least on depth data and segmentation data.

The method 400, at block B402, includes generating, using an encoder, a set of one or more feature extractions based at least on a first input from an optical image sensor comprising optical image data representing an image of a three-dimensional (3D) environment, and a second input comprising at least one 3D geometry prior representing at least one or more surface regions of structural elements within the 3D environment as viewed by the optical image sensor. For example, as discussed herein, an optical depth estimation model 120 may generate 3D depth estimate data 130 based on optical image data 107 and at least one 3D geometry prior 108. The optical image data 107 may comprise one or more image frames of an interior space described at least in part by the 3D geometry prior 108. The optical depth estimation model may include an encoder stage that comprises an encoder model and a decoder stage that comprises a plurality of decoder models and includes at least a depth estimation decoder and a segmentation decoder.

The optical depth estimation model may be trained to generate the depth map based at least on a joint learning framework based at least on a loss function that includes a predicted segmentation loss and a predicted depth loss. In some embodiments, the optical depth estimation model is trained to generate the depth map based on a segmentation loss that represents an edge alignment loss. In some embodiments, the optical depth estimation model is trained to generate the depth map based on a depth consistency loss that represents a perceptual loss.

In some embodiments, the method may include a data alignment of the 3D geometry priors, a process that at least approximately aligns a virtual camera having the field of view of the 3D geometry prior rendered images, with the field of view of the physical OMS optical image sensor in the real vehicle. For example, a viewpoint of the at least one 3D geometry prior may be aligned with a field of view of the optical image sensor within an alignment threshold. In some embodiments, the at least one 3D geometry prior comprises at least one of a point cloud representation of the one or more surface regions, a 3D model of the one or more surface regions, or a rendered depth image of the one or more surface regions. In some embodiments, a 3D geometry prior may represent a vehicle interior space (e.g., a cabin, cargo space, or other interior space of a vehicle). However, the 3D geometry prior is not limited to representations of a vehicle interior space. In some embodiments, the 3D geometry prior may represent structural features of spaces such as retail shops, bank lobbies, hospital rooms, warehouse areas, gymnasiums, containers, airport terminals, mines, factories, construction zones, and/or studio sets. That is, 3D geometry prior 108 may represent any interior space defined by a bounded spatially constrained 3D environment. The optical image data may be provided as the first input to a first neural network layer of the encoder stage, and the at least one 3D geometry prior is provided as the second input to a second neural network layer of the encoder stage subsequent to the first neural network layer. That is, in some embodiments, the architecture of the encoder stage is designed to take as inputs both the optical image sensor data and the 3D geometry priors. Alternatively, or additionally, 3D geometry priors can be integrated as inputs to intermediate layers of the encoder stage, serving as a reference or guide with which the optical depth estimation model learns to align its depth and segmentation predictions.

The method 400, at block B404, includes generating, using a decoder, an output comprising a depth map of the three-dimensional (3D) environment corresponding to the optical image data based at least on the set of one or more feature extractions, wherein the decoder is trained to infer depth data and a segmentation mask based at least on the one or more feature extractions. The encoder stage may be trained to generate a set of one or more feature extractions (based on the optical image data 107 and at least one 3D geometry prior 108), and the decoder stage trained to infer depth data and a segmentation mask based on the set of one or more feature extractions to generate the depth map. The optical depth estimation model may infer a segmentation of the scene based on the optical image data and the representation of the 3D geometry prior, predict a depth parameter scaling for the non-static regions, and output a prediction of depth information in the form of the depth map that can be aligned pixel-wise with the optical image data. The optical depth estimation model may generate the depth map based on a segmentation of the optical image data that segments regions inferred to be static regions from regions inferred to be non-static regions. A distance to features appearing at given pixel locations of a captured image frame—from the OMS optical image sensor that captured the image frame—may therefore be determined based on referencing those locations on the depth map. The value of a pixel on the depth map provides a depth estimate of the feature appearing at a corresponding pixel of the image frame.

In some embodiments, the method may include controlling at least one operation of a machine based at least on the depth map. The depth map may be input to an occupant evaluation function to produce 3D occupant representation data. For example, the method may include determining at least one of a pose or size of an occupant within the 3D environment based at least on the depth map. In some embodiments, a characteristic representing the size of the occupant from the 3D occupant representation data may be used in conjunction with a child-presence detection system to estimate an age of the occupant, and/or control an alert system (e.g., alarm and/or notification systems) based on determining that an occupant under an estimated age threshold may have been inadvertently left alone in the vehicle. In some embodiments, the characteristic representing the size of the occupant may be used in conjunction with other vehicle safety features. For example, in some embodiments, airbag deployments, driver monitoring systems, HMI applications, and/or other vehicle functions may be controlled based at least on a 3D pose, 3D shape, and/or 3D size estimate of the vehicle occupant provided by the 3D occupant representation data.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated sensor data and/or map data may be used that includes the application of realistic OMS-generated depth data within the simulation environment, and may use this information to perform operations (e.g., navigating, vehicle safety features, etc.) associated with the virtual machine within the environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. The synthetic training data (in addition to or alternatively from real-world data) may then be processed to determine a pose or size of the driver and/or other occupant, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation. In some embodiments, one or more driver assistance functions may be operated based at least one depth estimate output (e.g., a depth map) from the optical depth estimation model 120 such as 3D depth estimate data 130 and/or depth map 320.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to allow the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to allow autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LiDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), one or more occupant monitoring system (OMS) sensor(s) 501 (e.g., one or more interior cameras), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three-dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

Cameras with a field of view that include portions of the interior environment within the cabin of the vehicle 500 (e.g., one or more OMS sensor(s) 501) may be used as part of an occupant monitoring system (OMS) such as, but not limited to, a driver monitoring system (DMS). For example, OMS sensors (e.g., the OMS sensor(s) 501) may be used (e.g., by the controller(s) 536) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle). In some embodiments OMS sensor(s) 501 may comprise optical image sensor(s) 106 and/or optical image sensor(s) 306 and 3D depth estimate data 130 used as an input to the OMS of vehicle 500.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation allowing any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508. In some embodiments, the optical depth estimation model 120 and/or occupant assessment system 300 may be implemented using code executing on CPU(s) 506 and/or the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types - for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations, such as but not limited to the optical depth estimation model 120. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing, such as performed by optical depth estimation model 120. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks (e.g., optical depth estimation model 120), especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LiDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to allow communication with peripherals, audio codecs, power management, and/or other devices. The SoC(s) 504 may be used to process data from cameras (e.g., connected over Gigabit Multimedia Serial Link and Ethernet), sensors (e.g., LiDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500. In some embodiments, the optical depth estimation model 120 and/or occupant assessment system 300 may be implemented using code executing on CPU(s) 518 and/or GPU(s) 520.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to allow wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated using the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LiDAR sensor(s) 564. The LiDAR sensor(s) 564 may be used for object and pedestrian detection, emergency braking, collision avoidance, and/or other functions. The LiDAR sensor(s) 564 may be functional safety level ASIL B. In some examples, the vehicle 500 may include multiple LiDAR sensors 564 (e.g., two, four, six, etc.) that may use Ethernet (e.g., to provide data to a Gigabit Ethernet switch).

In some examples, the LiDAR sensor(s) 564 may be capable of providing a list of objects and their distances for a 360-degree field of view. Commercially available LiDAR sensor(s) 564 may have an advertised range of approximately 500 m, with an accuracy of 2 cm-3 cm, and with support for a 500 Mbps Ethernet connection, for example. In some examples, one or more non-protruding LiDAR sensors 564 may be used. In such examples, the LiDAR sensor(s) 564 may be implemented as a small device that may be embedded into the front, rear, sides, and/or corners of the vehicle 500. The LiDAR sensor(s) 564, in such examples, may provide up to a 120-degree horizontal and 35-degree vertical field-of-view, with a 200 m range even for low-reflectivity objects. Front-mounted LiDAR sensor(s) 564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may allow the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LiDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. As such, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(D) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks, optical depth estimation model 120) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. In some embodiments, training may include training of the optical depth estimation model 120 as illustrated in FIG. 2. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, one or more aspects of the optical depth estimation model 120 and/or occupant assessment system 300 may be implemented at least in part using computing device(s) 600.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608. In some embodiments, the optical depth estimation model 120 and/or occupant assessment system 300 may be implemented at least in part by code executing on the CPU(s) 606, the GPU(s) 608, and/or the logic unit(s) 620.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740. In some embodiments, one or more functions of the optical depth estimation model 120 and/or occupant assessment system 300 may be implemented at least in part by data center 700.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). In some embodiments, one or more functions of the optical depth estimation model 120 and/or occupant assessment system 300 may be implemented at least in part by code executing on the node C.R.s 716(1)-7161(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising circuitry to:
generate, using an encoder, a set of one or more feature extractions based at least on a first input from an optical image sensor comprising optical image data representing an image of a three-dimensional (3D) environment, and a second input comprising at least one 3D geometry prior representing at least one or more surface regions of structural elements within the 3D environment as viewed by the optical image sensor; and
generate, using a decoder, an output comprising a depth map of the three-dimensional (3D) environment corresponding to the optical image data based at least on the set of one or more feature extractions, wherein the decoder is trained to infer depth data and a segmentation mask based at least on the one or more feature extractions.

2. The one or more processors of claim 1, wherein the encoder comprises an encoder model and the decoder comprises a plurality of decoder models that include at least a depth estimation decoder and a segmentation decoder.

3. The one or more processors of claim 1, wherein the depth map is generated based at least on a joint learning framework based at least on a loss function that includes a predicted segmentation loss and a predicted depth loss.

4. The one or more processors of claim 3, wherein the depth map is generated based on at least one of an edge alignment loss or a perceptual loss.

5. The one or more processors of claim 1, wherein the one or more processors align a viewpoint of the at least one 3D geometry prior with a field of view of the optical image sensor within an alignment threshold.

6. The one or more processors of claim 1, wherein the one or more processors are further to control at least one operation of a machine based at least on the depth map.

7. The one or more processors of claim 1, wherein the one or more processors are further to determine at least one of a pose or size of an occupant within the 3D environment based at least on the depth map.

8. The one or more processors of claim 1, wherein the at least one 3D geometry prior comprises at least one of a point cloud representation of the one or more surface regions, a 3D model of the one or more surface regions, or a rendered depth image of the one or more surface regions.

9. The one or more processors of claim 1, wherein the optical image data is provided as the first input to a first neural network layer of the encoder, and the at least one 3D geometry prior is provided as the second input to a second neural network layer of the encoder subsequent to the first neural network layer.

10. The one or more processors of claim 1, wherein the one or more processors are further to generate the depth map based on a segmentation of the optical image data that segments regions inferred to be static regions from regions inferred to be non-static regions.

11. The one or more processors of claim 1, wherein the circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device;
a system implemented using a robot;
a system for performing conversational artificial intelligence (AI) operations;
a system implementing one or more language models;
a system implementing one or more large language models (LLMs);
a system implementing one or more vision language models (VLMs);
a system for performing generative AI operations;
a system for generating synthetic data;
a system incorporating one or more virtual machines (VMs);
a system implemented at least partially in a data center; or
a system implemented at least partially using cloud computing resources.

12. A system comprising one or more processors to:
generate a set of one or more feature extractions based at least on an input from an optical image sensor comprising optical image data representing an image of a three-dimensional (3D) environment and at least one 3D geometry prior representing the 3D environment; and
generate an output comprising a depth map of estimated depths corresponding to the 3D environment based at least on predicted depth data and a predicted segmentation mask inferred from the set of one or more feature extractions.

13. The system of claim 12, wherein the one or more processors are further to:
execute an optical depth estimation model comprising:
an encoder stage to generate the set of one or more feature extractions; and
a decoder stage trained to infer depth data and a segmentation mask based at least on one or more feature extractions to generate the depth map.

14. The system of claim 13, wherein the decoder stage comprises a plurality of decoder models that include at least a depth estimation decoder and a segmentation decoder.

15. The system of claim 13, wherein the optical depth estimation model is trained to generate the depth map based at least on a joint learning framework based at least on a loss function that includes a predicted segmentation loss and a predicted depth loss.

16. The system of claim 12, wherein the one or more processors align a viewpoint of the at least one 3D geometry prior with a field of view of the optical image sensor within an alignment threshold.

17. The system of claim 12, wherein the one or more processors are further to control at least one operation of a machine based at least on the depth map.

18. The system of claim 12, wherein the one or more processors are further to generate the depth map based on a segmentation of the optical image data that segments regions inferred to be static regions from regions inferred to be non-static regions.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device;
a system implemented using a robot;
a system for performing conversational artificial intelligence (AI) operations;
a system implementing one or more language models;
a system implementing one or more large language models (LLMs);
a system implementing one or more vision language models (VLMs);
a system for performing generative AI operations;
a system for generating synthetic data;
a system incorporating one or more virtual machines (VMs);
a system implemented at least partially in a data center; or
a system implemented at least partially using cloud computing resources.

20. A method comprising:
controlling an operation of a machine based at least on generating a depth map of estimated depths corresponding to a three-dimensional (3D) environment based at least on monocular optical image data representing an image of the 3D environment and at least one 3D geometry prior representing the 3D environment, wherein the depth map is generated using a depth estimation model trained to infer compute depth maps based at least on depth data and segmentation data.
